(19) United States
(12) Patent Application Publication
(10) Pub. No.: US 2026/0134106 A1
(43) Pub. Date: May 14, 2026

(54) Concurrently Installing Updates on Containers

(71) Applicant: International Business Machines Corporation, Armonk, NY (US)

(72) Inventors: Xiao Ling Chen, Beijing (CN); Yan Fei Qin, Beijing (CN); Yuan Li, Beijing (CN); Zhan Peng Huo, Beijing (CN)

(21) Appl. No.: 18/942,984

(22) Filed: Nov. 11, 2024

(51) Int. Cl. G06F 21/57; G06F 8/61; G06F 8/65

(52) U.S. Cl. CPC G06F 21/577; G06F 8/63; G06F 8/65; G06F 2221/033

(57) ABSTRACT

Managing container updates is provided. An update corresponding to a software vulnerability is downloaded to a container layer of the container. The update corresponding to the software vulnerability is moved from the container layer to a reserved top image layer of the container based on a cache identifier corresponding to the reserved top image layer to fix the software vulnerability.

### BACKGROUND

The disclosure relates generally to container-based environments and more specifically to managing container updates.

A container-based environment, architecture, platform, or the like, such as, for example, Kubernetes® (a registered trademark of the Linux Foundation of San Francisco, CA, USA), provides a structural design for automating deployment, scaling, and operations of containers across host nodes. A host node is a machine, either physical or virtual, where containers (i.e., application workloads) are deployed. A container is a version of a container image and is ready to run as an application, which corresponds to a service. In other words, the container image becomes the container at runtime. The container image is an executable package of software that includes everything needed to run the application (e.g., code, runtime, system tools, system libraries, settings, and the like).

### SUMMARY

According to one illustrative embodiment, a method is provided. The method downloads an update corresponding to a software vulnerability to a container layer of the container. The method moves the update corresponding to the software vulnerability from the container layer to a reserved top image layer of the container based on a cache identifier corresponding to the reserved top image layer to fix the software vulnerability. According to other illustrative embodiments, a computer system and computer program product are provided.

### BRIEF DESCRIPTION OF THE DRAWINGS

FIG. 1 is a pictorial representation of a computing environment in which illustrative embodiments may be implemented;

FIG. 2 is a diagram illustrating an example of a container update management system in accordance with an illustrative embodiment;

FIG. 3 is a diagram illustrating an example of a reserved top image layer generation process in accordance with an illustrative embodiment;

FIG. 4 is a diagram illustrating an example of an addressing image layers process in accordance with an illustrative embodiment;

FIG. 5 is a diagram illustrating an example of a container update process in accordance with an illustrative embodiment;

FIG. 6 is a flowchart illustrating a process for generating a reserved top image layer in a container in accordance with an illustrative embodiment; and

FIGS. 7A-7B are a flowchart illustrating a process for installing container updates in accordance with an illustrative embodiment.

### DETAILED DESCRIPTION

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A CPP embodiment is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

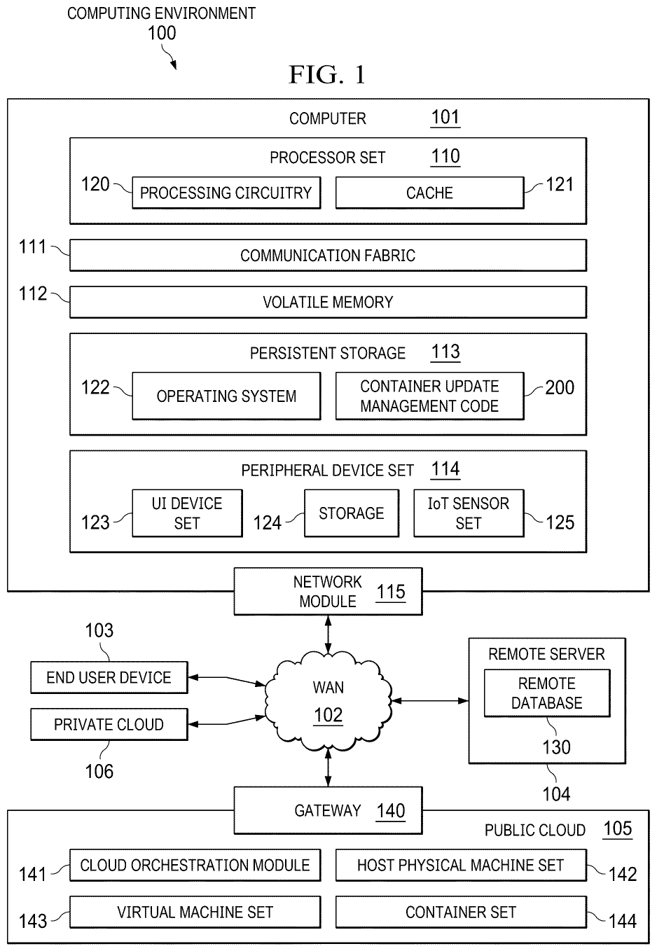

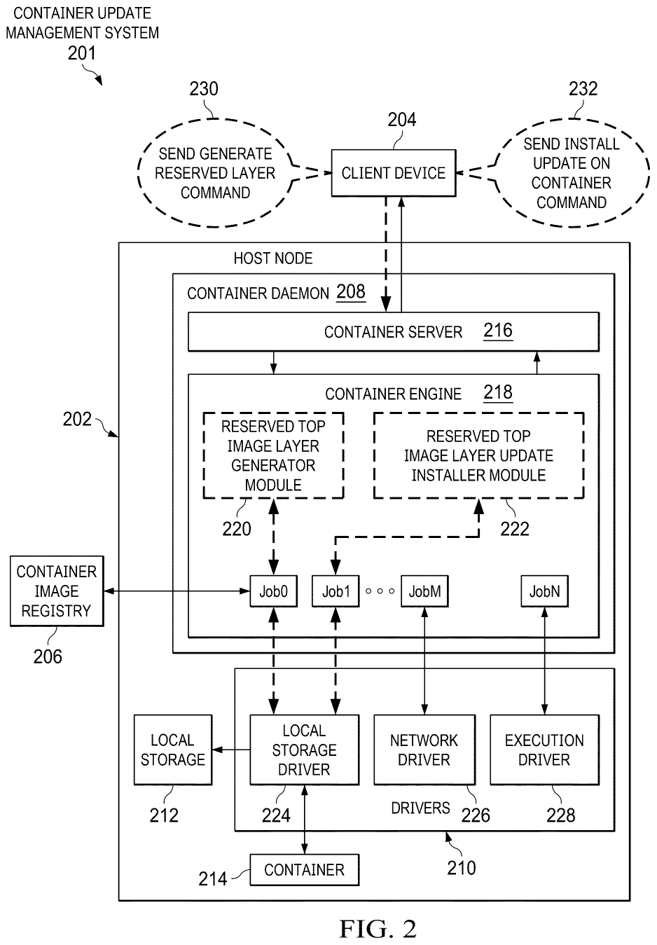

With reference now to the figures, and in particular, with reference to FIG. 1 and FIG. 2, diagrams of data processing environments are provided in which illustrative embodiments may be implemented. It should be appreciated that FIG. 1 and FIG. 2 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of a container-based environment for the execution of at least some of the computer code involved in performing the inventive methods of illustrative embodiments, such as container update management code 200. For example, container update management code 200 ensures improved use of container capabilities, automation, and resiliency by installing updates (e.g., patches, fixes, new features, and the like) at the same time to take effect on all containers built with the same container image version in the container-based environment.

In addition to container update management code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and container update management code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a mainframe computer, quantum computer, desktop computer, laptop computer, tablet computer, or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods of illustrative embodiments may be stored in container update management code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as smart glasses and smart watches), keyboard, mouse, printer, touchpad, and haptic devices.

Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers.

IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any computer system that is used and controlled by an end user (e.g., a container developer, container user, system administrator, or the like who is utilizing the container update management services provided by computer 101), and may take any of the forms discussed above in connection with computer 101. EUD 103 typically receives helpful and useful data from the operations of computer 101. For example, in a hypothetical case where computer 101 is designed to provide a container update recommendation to the end user, this recommendation would typically be communicated from network module 115 of computer 101 through WAN 102 to EUD 103. In this way, EUD 103 can display, or otherwise present, the container update recommendation to the end user. In some embodiments, EUD 103 may be a client device, such as a thin client, heavy client, mainframe computer, desktop computer, laptop computer, tablet computer, smart phone, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a container update recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

Based on current container technology, when committing a container image, a container developer, provider, or the like packages the contents of the image layers and pushes the image layers in the form of a container image to a container image repository. When pulling a container image from the container image repository, a container user downloads the contents of the specified image layers and all parent layers to a local container on a host node. In other words, the user downloads all image layers of the container image to the container on the host node.

However, after a container is initially released, updates (e.g., patches, new features, and the like) are continuously being delivered. For a user at the enterprise level, the user typically needs to install new security patches or features as soon as possible to increase security by preventing exposure to software vulnerabilities. Most of the time, the user has to install these updates directly on a multitude of running containers built using the same container image version that is being exploited by a software vulnerability. For example, tens, hundreds, or even thousands of running containers may need an update for a detected high-severity software vulnerability. However, delivering the update for the detected high-severity software vulnerability takes time (e.g., the container developer may take 30 days or longer to create and deliver a new image layer for the containers that includes the needed fix for the detected high-severity software vulnerability). This delay in delivering needed updates particularly impacts frequent large-scale container security update installation projects.

As an illustration, for an update delivery service, the latest available update is in a particular image layer, such as image layer 3, of a container. The container developer is planning to deliver a new image layer (e.g., image layer 4) for the container to fix one or more software vulnerabilities in several months. However, the enterprise-level user needs to install the software vulnerability fixes on a multitude of running containers as soon as possible. Because the new image layer (e.g., image layer 4) for fixing the one or more software vulnerabilities is not currently available, the enterprise-level user cannot pull the new image layer from the container image registry and apply the new image layer to the running containers to prevent exploitation of the one or more software vulnerabilities by malicious users.

Illustrative embodiments increase container capabilities, automation, and resiliency by installing updates, such as, for example, patches, fixes, new features, and the like, to take effect at the same time on all software vulnerability-exposed containers built using the same container image version. Illustrative embodiments achieve this by utilizing a reserved top image layer of the software vulnerability-exposed containers when installing the one or more software vulnerability fixes on the software vulnerability-exposed containers. By utilizing the reserved top image layer of the software vulnerability-exposed containers, illustrative embodiments can increase the security of production systems as quickly as possible by preventing exposure to the software vulnerabilities as much as possible.

Illustrative embodiments generate the reserved top image layer (i.e., a new empty image layer) in a container to locally store and install a set of updates (e.g., new features, patches, fixes or the like) on the container. Illustrative embodiments utilize a new “generate reserved layer” command that triggers a new reserved top image layer generator module to construct the new reserved top image layer in the container. As an example, the current top image layer of a container is image layer 3. Illustrative embodiments utilize the “generate reserved layer” command to invoke the reserved top image layer generator module to construct the reserved top image layer (e.g., image layer 4) in the container. The reserved top image layer generator module also generates a specialized chain identifier (ID) for the reserved top image layer that includes a difference folder ID, a parent layer ID, and a cache ID corresponding to the reserved top image layer.

Illustrative embodiments also utilize a new “install update on container” command that triggers a new reserved top image layer update installer module to move installation files corresponding to the update that were downloaded on the container layer of the container to a difference folder under a cache ID of the reserved top image layer. For example, an “install vulnerability XXXX fix on container” command invokes the reserved top image layer update installer module to install the specified vulnerability XXXX fix in the reserved top image layer of the vulnerability XXXX-exposed container instead of in the container layer of the container. The reserved top image layer update installer module locates the installation files on the container layer of one vulnerability XXXX-exposed container in the container-based environment. The vulnerability XXXX-exposed container can be any container of the running containers in the container-based environment or a backup container.

After locating the installation files in the container layer of the container, the reserved top image layer update installer module then moves the installation files from the container layer to the difference folder under the cache ID of the reserved top image layer of the container to fix vulnerability XXXX on the container. Further, the reserved top image layer update installer module shares the installation files containing the fix for vulnerability XXXX with other containers built using the same container image version in the container-based environment.

Accordingly, illustrative embodiments enable users to install updates on software vulnerability-exposed containers at the same time to take effect on all software vulnerability-exposed containers built using the same container image version without waiting for the new image layer to be delivered to the container image repository or repeating the update installation process on a multitude of containers individually. Further, illustrative embodiments are transparent to both the container developers and users. In addition, both container developers and users can maintain and upgrade an entire container-based environment without frequently implementing installations of updates on all vulnerability-exposed containers.

Thus, illustrative embodiments provide one or more technical solutions that overcome a technical problem with an inability of current solutions to concurrently update a plurality of containers built using the same container image version in a container-based environment. As a result, these one or more technical solutions provide a technical effect and practical application in the field of container-based environments.

With reference now to FIG. 2, a diagram illustrating an example of a container update management system is depicted in accordance with an illustrative embodiment. Container update management system 201 may be implemented in a container-based environment, such as computing environment 100 in FIG. 1. Container update management system 201 is a system of hardware and software components for installing updates (e.g., patches, fixes, new features, and the like) at the same time to take effect on all of a plurality of containers built with the same container image version in the container-based environment.

In this example, container update management system 201 includes host node 202, client device 204, and container image registry 206. Host node 202 can be, for example, computer 101 in FIG. 1. Client device 204 can be, for example, EUD 103 in FIG. 1. Container image registry 206 can be, for example, remote database 130 in FIG. 1. Container image registry 206 stores a plurality of different container images. However, it should be noted that container update management system 201 is intended as an example only and not as a limitation on illustrative embodiments. For example, container update management system 201 can include any number of host nodes, client devices, container image registries, and other devices and components not shown.

In this example, host node 202 includes container daemon 208, drivers 210, local storage 212, and container 214. Container daemon 208 provides the runtime environment for containers, such as container 214, running on host node 202. Container daemon 208 includes container server 216 and container engine 218. Container engine 218 includes reserved top image layer generator module 220 and reserved top image layer update installer module 222. Reserved top image layer generator module 220 and reserved top image layer update installer module 222 may be implemented by container update management code 200 in FIG. 1.

In this example, drivers 210 include local storage driver 224, network driver 226, and execution driver 228. Reserved top image layer generator module 220 and reserved top image layer update installer module 222 utilize local storage driver 224 to manage updates to layers in container 214.

Host node 202 utilizes container 214 to execute an application workload that provides a service corresponding to a production system. Host node 202 runs container 214 using one or more container images stored in local storage 212. Container 214 includes a set of image layers and a container layer above the set of image layers. Container 214 may represent a plurality of different containers.

At 230, a user (e.g., container developer, container user, system administrator, or the like) of client device 204 sends a “generate reserved layer” command to reserved top image layer generator module 220 via container server 216 and container engine 218 of host node 202. In response to receiving the “generate reserved layer” command, reserved top image layer generator module 220 constructs a reserved top image layer above the set of existing image layers in container 214. Initially, the reserved top image layer is an empty directory without any files.

At 232, the user of client device 204 also sends a “install update on container” command to reserved top image layer update installer module 222 via container server 216 and container engine 218 of host node 202. In response to receiving the “install update on container” command, reserved top image layer update installer module 222 downloads, for example, an update corresponding to a fix for a software vulnerability detected in one of the image layers of container 214 to the container layer of container 214. Afterward, reserved top image layer update installer module 222 moves the update from the container layer to the reserved top image layer to fix the software vulnerability.

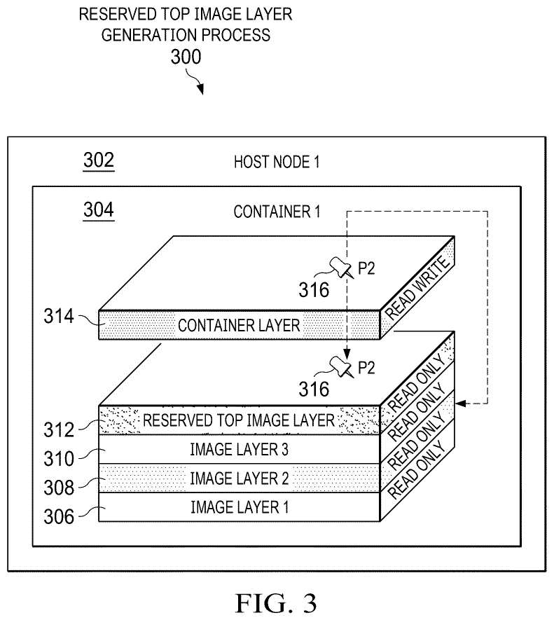

With reference now to FIG. 3, a diagram illustrating an example of a reserved top image layer generation process is depicted in accordance with an illustrative embodiment. Reserved top image layer generation process 300 is implemented in host node 1 302. Host node 1 302 may be, for example, host node 202 in FIG. 2 or computer 101 in FIG. 1. Host node 302 is located in a container-based environment, such as, for example, computing environment 100 in FIG. 1, and is one of a plurality of host nodes running containers.

In this example, host node 1 302 runs container 1 304. Container 1 304 may be, for example, container 214 in FIG. 2. Also in this example, container 1 304 includes image layer 1 306, image layer 2 308, image layer 3 310, reserved top image layer 312, and container layer 314. Image layer 1 306, image layer 2 308, image layer 3 310, and reserved top image layer 312 are read only layers of container 1 304. Also, reserved top image layer 312 is a newly added empty image layer (e.g., no files initially) in container 1 304. Container layer 314 is a read and write layer of container 1 304 and is a working layer that processes inputs and outputs of the service provided by the application running on container 1 304.

Illustrative embodiments utilize a reserved top image layer generator module, such as, for example, reserved top image layer generator module 220 in FIG. 2, to generate reserved top image layer 312. The reserved top image layer generator module generates reserved top image layer 312 in response to receiving a “generate reserved layer” command from a client device, such as, for example, client device 204 in FIG. 2. In addition, illustrative embodiments use a reserved top image layer update installer module, such as, for example, reserved top image layer update installer module 222 in FIG. 2, to download update installation packages, such as patches, fixes, new features, and the like, from a trusted and secure website onto container layer 314 initially. The reserved top image layer update installer module downloads the update installation packages in response to receiving a “install update on container” command from the client device. Subsequently, the reserved top image layer update installer module moves the downloaded update installation packages down to reserved top image layer 312 from container layer 314.

As an illustration, in this example illustrative embodiments detect that image layer 2 308 has a software vulnerability. Illustrative embodiments also identify that patch P2 316 is a fix for the detected software vulnerability. Illustrative embodiments download an installation package for patch P2 316 from a trusted and secure website onto container layer 316. Illustrative embodiments then move the installation package for patch P2 316 down to reserved top image layer 312 to fix the detected software vulnerability in image layer 2 308. Based on the mechanism of the union file system, reserved top image layer 312 is higher than image layer 2 308 on the mount point view of container 1 304. As a result, the new files to fix the detected software vulnerability in image layer 2 308 will be the installation package files of patch P2 316 in reserved top image layer 312.

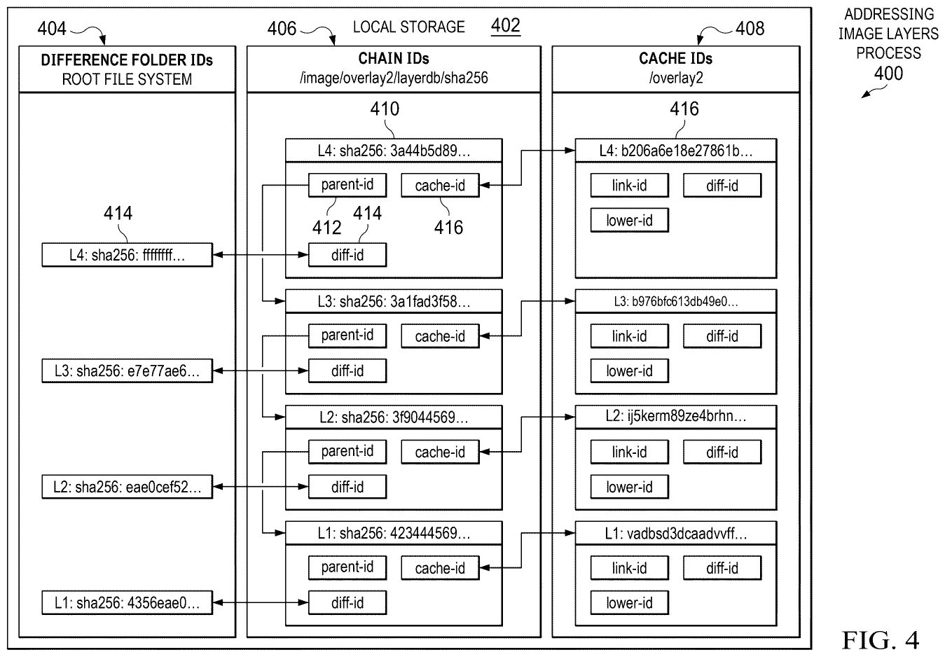

With reference now to FIG. 4, a diagram illustrating an example of an addressing image layers process is depicted in accordance with an illustrative embodiment. Addressing image layers process 400 is implemented in local storage 402, such as, for example, local storage 212 in FIG. 2. Addressing image layers process 400 is implemented by a reserved top image layer generator module, such as, for example, reserved top image layer generator module 220 in FIG. 2. In this example, local storage 402 contains difference folder identifiers (IDs) 404, chain IDs 406, and cache IDs 408.

The reserved top image layer generator module constructs a reserved top image layer above a set of existing image layers in a container, such as, for example, reserved top image layer 312 above image layer 1 306, image layer 2 308, and image layer 3 310 in container 1 302 of FIG. 3. The reserved top image layer generator module constructs the reserved top image layer in response to receiving a “generate reserved layer” command from a client device, such as, for example, client device 204 in FIG. 2.

In this example, the reserved top image layer is reserved top image layer “L4”. In addition, the reserved top image layer generator module generates chain ID 410 for reserved top image layer L4. Chain ID 410 for reserved top image layer L4 also includes parent layer ID 412, difference folder ID 414, and cache ID 416.

In this example, chain ID 410 for reserved top image layer L4 is sha256: 3a44b5d89 . . . , with parent layer ID 412 that is sha256: 3a1fad3f58 . . . for the previous top image layer “L3,” difference folder ID 414 that is sha256: ffffffff . . . for the reserved top image layer L4, and cache ID 416 that is b206a6e18e27861b . . . corresponding to the reserved top image layer L4. It should be noted that sha256: ffffffff . . . of difference folder ID 414 represents a predefined special hash value that the reserved top image layer generator module uses to identify L4 as the reserved top image layer containing, for example, an update to fix a software vulnerability detected in image layer “L2.”

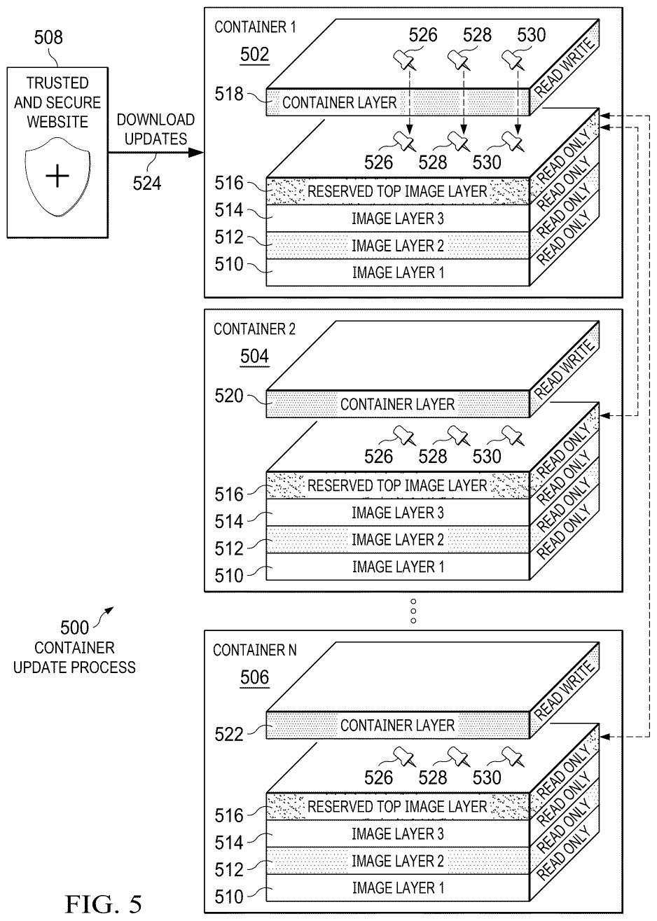

With reference now to FIG. 5, a diagram illustrating an example of a container update process is depicted in accordance with an illustrative embodiment. Container update process 500 is implemented by a reserved top image layer update installer module, such as, for example, reserved top image layer update installer module 222 in FIG. 2. The reserved top image layer update installer module performs container update process 500 in response to receiving an “install update on container” command from a client device, such as, client device 204 in FIG. 2.

In this example, container update process 500 includes container 1 502, container 2 504, container “N” 506, and trusted and secure website 508. However, it should be noted that container update process 500 is intended as an example only and not as a limitation on illustrative embodiments. In other words, container update process 500 may include any number of containers, trusted and secure websites, and other devices and components not shown. For example, container 1 502, container 2 504, and container “N” 506 run on host nodes, such as, for example, host node 202 in FIG. 2 or computer 101 in FIG. 1.

In this example, each of container 1 502, container 2 504, and container “N” 506 include image layer 1 510, image layer 2 512, image layer 3 514, and reserved top image layer 516. Each of image layer 1 510, image layer 2 512, image layer 3 514, and reserved top image layer 516 is a read only layer. In addition, container 1 502 includes container layer 518, container 2 504 includes container layer 520, and container “N” 506 includes container layer 522. Each of container layer 518, container layer 520, and container layer 522 is a read and write layer that is the working layer for its corresponding container.

At 524, in response to receiving the “install update on container” command, the reserved top image layer update installer module downloads from trusted and secure website 508 a set of updates corresponding to a detected software vulnerability in image layer 2 512 of container 1 502, container 2 504, and container N 506, respectively. It should be noted that each of container 1 502, container 2 504, and container N 506 was generated using the same container image version.

In this example, the set of updates includes patch 526, patch 528, and patch 530 that contain the fix for the software vulnerability detected in image layer 2 512. The reserved top image layer update installer module initially downloads patch 526, patch 528, and patch 530 into container layer 518 of container 1 502. However, it should be noted that illustrative embodiments can download the patches into any one of the running containers or a backup container in the container-based environment.

After downloading patch 526, patch 528, and patch 530 into container layer 518 of container 1 502, the reserved top image layer update installer module moves patch 526, patch 528, and patch 530 to a difference file folder in reserved top image layer 516 under the cache ID corresponding to reserved top image layer 516 to fix the software vulnerability. As a result, the union file system shares patch 526, patch 528, and patch 530 on reserved top image layer 516 in container 1 502 with container 2 504 to container N 506.

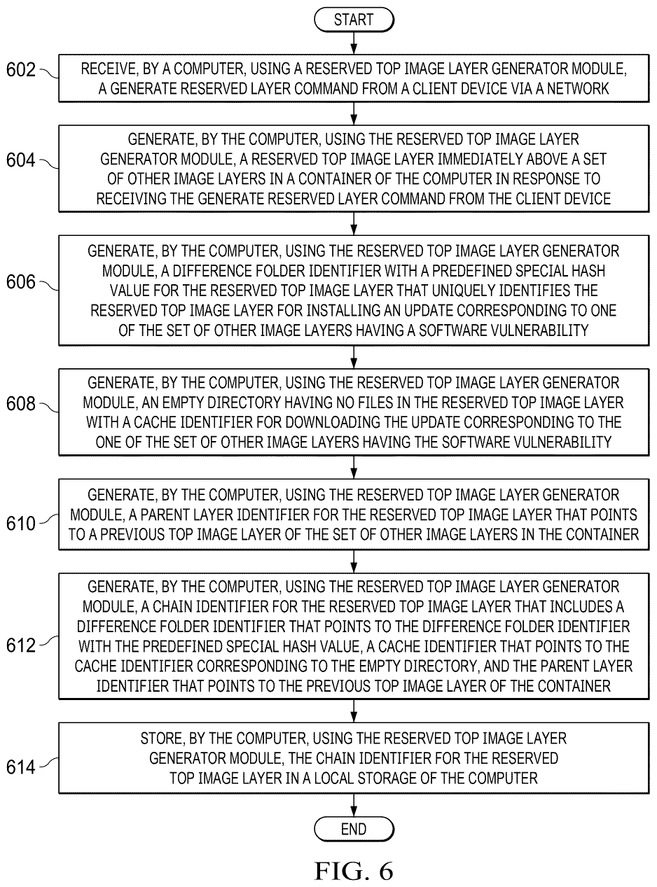

With reference now to FIG. 6, a flowchart illustrating a process for generating a reserved top image layer in a container is shown in accordance with an illustrative embodiment. The process shown in FIG. 6 may be implemented in a computer, such as, for example, computer 101 in FIG. 1 or host node 202 in FIG. 2. For example, the process shown in FIG. 6 may be implemented by container update management code 200 in FIG. 1 or reserved top image layer generator module 220 in FIG. 2.

The process begins when the computer, using the reserved top image layer generator module, receives a generate reserved layer command from a client device via a network (step 602). The computer, using the reserved top image layer generator module, generates a reserved top image layer immediately above a set of other image layers in a container of the computer in response to receiving the generate reserved layer command from the client device (step 604).

In addition, the computer, using the reserved top image layer generator module, generates a difference folder identifier with a predefined special hash value for the reserved top image layer that uniquely identifies the reserved top image layer for installing an update corresponding to one of the set of other image layers having a software vulnerability (step 606). Further, the computer, using the reserved top image layer generator module, generates an empty directory having no files in the reserved top image layer with a cache identifier for downloading the update corresponding to the one of the set of other image layers having the software vulnerability (step 608).

Furthermore, the computer, using the reserved top image layer generator module, generates a parent layer identifier for the reserved top image layer that points to a previous top image layer of the set of other image layers in the container (step 610). Moreover, the computer, using the reserved top image layer generator module, generates a chain identifier for the reserved top image layer that includes a difference folder identifier that points to the difference folder identifier with the predefined special hash value, a cache identifier that points to the cache identifier corresponding to the empty directory, and the parent layer identifier that points to the previous top image layer of the container (step 612). The computer, using the reserved top image layer generator module, stores the chain identifier for the reserved top image layer in a local storage of the computer (step 614). Thereafter, the process terminates.

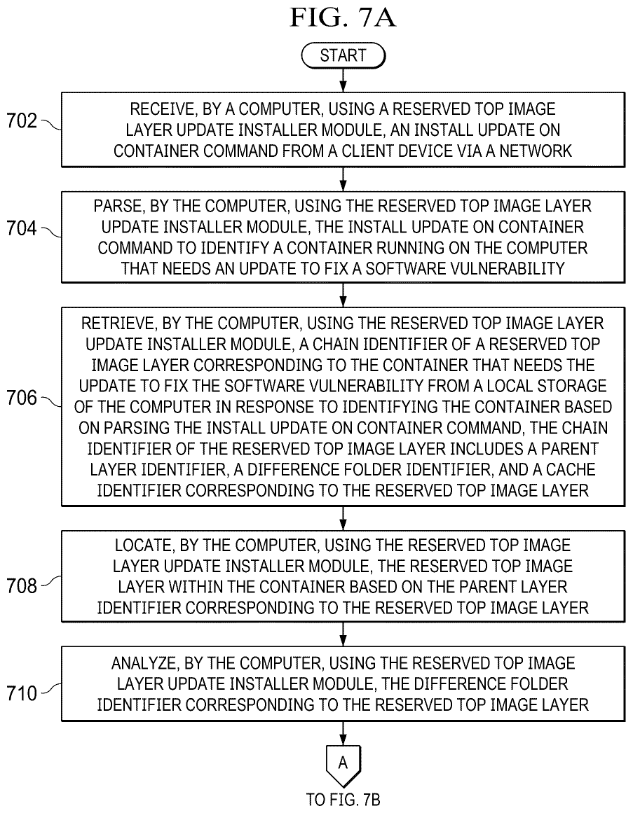

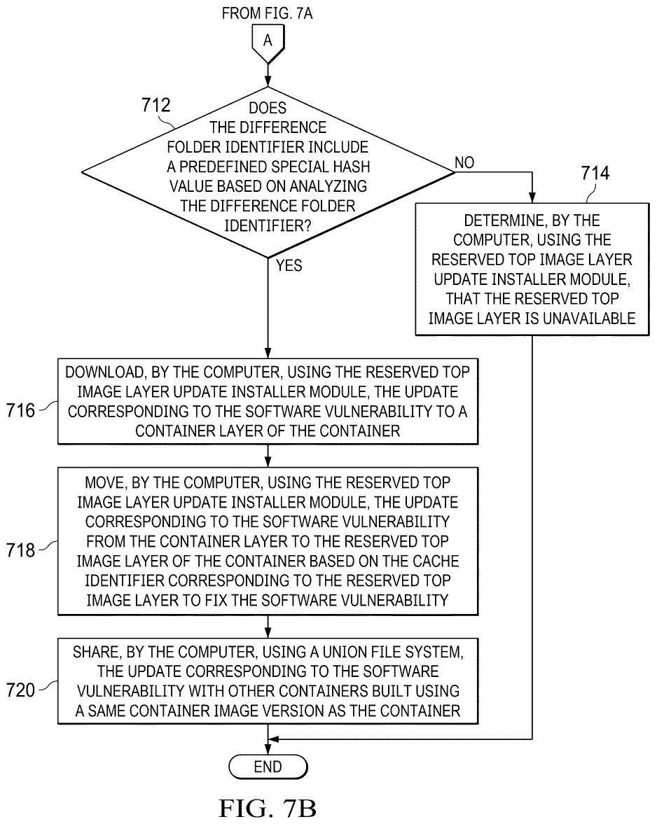

With reference now to FIGS. 7A-7B, a flowchart illustrating a process for installing container updates is shown in accordance with an illustrative embodiment. The process shown in FIGS. 7A-7B may be implemented in a computer, such as, for example, computer 101 in FIG. 1 or host node 202 in FIG. 2. For example, the process shown in FIGS. 7A-7B may be implemented by container update management code 200 in FIG. 1 or reserved top image layer update installer module 222 in FIG. 2.

The process begins when the computer, using the reserved top image layer update installer module, receives an install update on container command from a client device via a network (step 702). The computer, using the reserved top image layer update installer module, parses the install update on container command to identify a container running on the computer that needs an update to fix a software vulnerability (step 704).

The computer, using the reserved top image layer update installer module, retrieves a chain identifier of a reserved top image layer corresponding to the container that needs the update to fix the software vulnerability from a local storage of the computer in response to identifying the container based on parsing the install update on container command (step 706). The chain identifier of the reserved top image layer includes a parent layer identifier, a difference folder identifier, and a cache identifier corresponding to the reserved top image layer. The computer, using the reserved top image layer update installer module, locates the reserved top image layer within the container based on the parent layer identifier corresponding to the reserved top image layer (step 708).

In addition, the computer, using the reserved top image layer update installer module, analyzes the difference folder identifier corresponding to the reserved top image layer (step 710). The computer, using the reserved top image layer update installer module, makes a determination as to whether the difference folder identifier includes a predefined special hash value based on analyzing the difference folder identifier (step 712). In response to determining that the difference folder identifier does not include the predefined special hash value based on analyzing the difference folder identifier, no output of step 712, then the computer, using the reserved top image layer update installer module, determines that the reserved top image layer is unavailable (step 714). Thereafter, the process terminates.

In response to determining that the difference folder identifier does include the predefined special hash value based on analyzing the difference folder identifier, yes output of step 712, then the computer, using the reserved top image layer update installer module, downloads the update corresponding to the software vulnerability to a container layer of the container (step 716). Afterward, the computer, using the reserved top image layer update installer module, moves the update corresponding to the software vulnerability from the container layer to the reserved top image layer of the container based on the cache identifier corresponding to the reserved top image layer to fix the software vulnerability (step 718). Further, the computer, using a union file system, shares the update corresponding to the software vulnerability with other containers built using a same container image version as the container (step 720). Thereafter, the process terminates.

Thus, illustrative embodiments of the present disclosure provide a computer-implemented method, computer system, and computer program product for managing updates on a plurality of containers at the same time to prevent exposure to software vulnerabilities as quickly as possible. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
downloading an update corresponding to a software vulnerability to a container layer of the container; and
moving the update corresponding to the software vulnerability from the container layer to a reserved top image layer of the container based on a cache identifier corresponding to the reserved top image layer to fix the software vulnerability.

2. The method of claim 1, further comprising:
sharing, using a union file system, the update corresponding to the software vulnerability with other containers built using a same container image version as the container.

3. The method of claim 1, further comprising:
receiving an install update on container command from a client device via a network; and
parsing the install update on container command to identify the container that needs the update to fix the software vulnerability.

4. The method of claim 1, further comprising:
retrieving a chain identifier of the reserved top image layer corresponding to the container that needs the update to fix the software vulnerability from a local storage in response to identifying the container based on parsing an install update on container command, the chain identifier of the reserved top image layer includes a parent layer identifier, a difference folder identifier, and a cache identifier corresponding to the reserved top image layer; and
locating the reserved top image layer within the container based on the parent layer identifier corresponding to the reserved top image layer.

5. The method of claim 1, further comprising:
analyzing a difference folder identifier corresponding to the reserved top image layer;
determining whether the difference folder identifier includes a predefined hash value based on analyzing the difference folder identifier; and
responsive to determining that the difference folder identifier does include the predefined hash value based on analyzing the difference folder identifier, downloading the update corresponding to the software vulnerability to the container layer of the container.

6. The method of claim 5, further comprising:
responsive to determining that the difference folder identifier does not include the predefined hash value based on analyzing the difference folder identifier, determining that the reserved top image layer is unavailable.

7. The method of claim 1, further comprising:
receiving a generate reserved layer command from a client device via a network; and
generating the reserved top image layer immediately above a set of other image layers in the container in response to receiving the generate reserved layer command from the client device.

8. The method of claim 1, further comprising:
generating a difference folder identifier with a predefined hash value for the reserved top image layer that identifies the reserved top image layer for installing the update corresponding to one of a set of other image layers having the software vulnerability; and
generating an empty directory in the reserved top image layer with a cache identifier for downloading the update corresponding to the one of the set of other image layers having the software vulnerability.

9. The method of claim 1, further comprising:
generating a parent layer identifier for the reserved top image layer that points to a previous top image layer of a set of other image layers in the container;
generating a chain identifier for the reserved top image layer that includes a difference folder identifier with a predefined hash value, a cache identifier corresponding to an empty directory, and a parent layer identifier that points to a previous top image layer of the container; and
storing the chain identifier for the reserved top image layer in a local storage.

10. A computer system comprising:
a processor set;
one or more computer-readable storage media; and
program instructions stored on the one or more computer-readable storage media to cause the processor set to perform operations comprising:
downloading an update corresponding to a software vulnerability to a container layer of the container; and
moving the update corresponding to the software vulnerability from the container layer to a reserved top image layer of the container based on a cache identifier corresponding to the reserved top image layer to fix the software vulnerability.

11. The computer system of claim 10, wherein the operations further comprise:
sharing, using a union file system, the update corresponding to the software vulnerability with other containers built using a same container image version as the container.

12. The computer system of claim 10, wherein the operations further comprise:
receiving an install update on container command from a client device via a network; and
parsing the install update on container command to identify the container that needs the update to fix the software vulnerability.

13. The computer system of claim 10, wherein the operations further comprise:
retrieving a chain identifier of the reserved top image layer corresponding to the container that needs the update to fix the software vulnerability from a local storage in response to identifying the container based on parsing an install update on container command, the chain identifier of the reserved top image layer includes a parent layer identifier, a difference folder identifier, and a cache identifier corresponding to the reserved top image layer; and
locating the reserved top image layer within the container based on the parent layer identifier corresponding to the reserved top image layer.

14. The computer system of claim 10, wherein the operations further comprise:
analyzing a difference folder identifier corresponding to the reserved top image layer;
determining whether the difference folder identifier includes a predefined hash value based on analyzing the difference folder identifier; and
responsive to determining that the difference folder identifier does include the predefined hash value based on analyzing the difference folder identifier, downloading the update corresponding to the software vulnerability to the container layer of the container.

15. A computer program product comprising:
one or more computer-readable storage media; and
program instructions stored on the one or more computer-readable storage media to perform operations comprising:
downloading an update corresponding to a software vulnerability to a container layer of the container; and
moving the update corresponding to the software vulnerability from the container layer to a reserved top image layer of the container based on a cache identifier corresponding to the reserved top image layer to fix the software vulnerability.

16. The computer program product of claim 15, wherein the operations further comprise:
sharing, using a union file system, the update corresponding to the software vulnerability with other containers built using a same container image version as the container.

17. The computer program product of claim 15, wherein the operations further comprise:
receiving an install update on container command from a client device via a network; and
parsing the install update on container command to identify the container that needs the update to fix the software vulnerability.

18. The computer program product of claim 15, wherein the operations further comprise:
retrieving a chain identifier of the reserved top image layer corresponding to the container that needs the update to fix the software vulnerability from a local storage in response to identifying the container based on parsing an install update on container command, the chain identifier of the reserved top image layer includes a parent layer identifier, a difference folder identifier, and a cache identifier corresponding to the reserved top image layer; and
locating the reserved top image layer within the container based on the parent layer identifier corresponding to the reserved top image layer.

19. The computer program product of claim 15, wherein the operations further comprise:
analyzing a difference folder identifier corresponding to the reserved top image layer;
determining whether the difference folder identifier includes a predefined hash value based on analyzing the difference folder identifier; and
responsive to determining that the difference folder identifier does include the predefined hash value based on analyzing the difference folder identifier, downloading the update corresponding to the software vulnerability to the container layer of the container.

20. The computer program product of claim 19, wherein the operations further comprise:
responsive to determining that the difference folder identifier does not include the predefined hash value based on analyzing the difference folder identifier, determining that the reserved top image layer is unavailable.
